(19) United States
(12) Patent Application Publication
(10) Pub. No.: US 2016/0060899 A1
(43) Pub. Date: Mar. 3, 2016

(54) Safety key for vehicle ignitions eliminating undesirable torque to avoid unintentional change in state of the ignition

(71) Applicant: Floyed Jeffries Duncan, JR., Brentwood, TN (US)

(72) Inventor: Floyed Jeffries Duncan, JR., Brentwood, TN (US)

(21) Appl. No.: 14/838,262

(22) Filed: Aug. 27, 2015

Related U.S. Application Data
(60) Provisional application No. 62/044,484, filed on Sep. 2, 2014.

(51) Int. Cl. E05B 19/00

(52) U.S. Cl. CPC E05B 19/00

(57) ABSTRACT

A design for a vehicle ignition key or retrofit thereof which eliminates or significantly reduces an unintentional torque from being transmitted to the ignition switch which may cause a change in state of that switch. This is accomplished by eliminating the lever arm of the key to key chain interface and allowing free rotation in that interface.

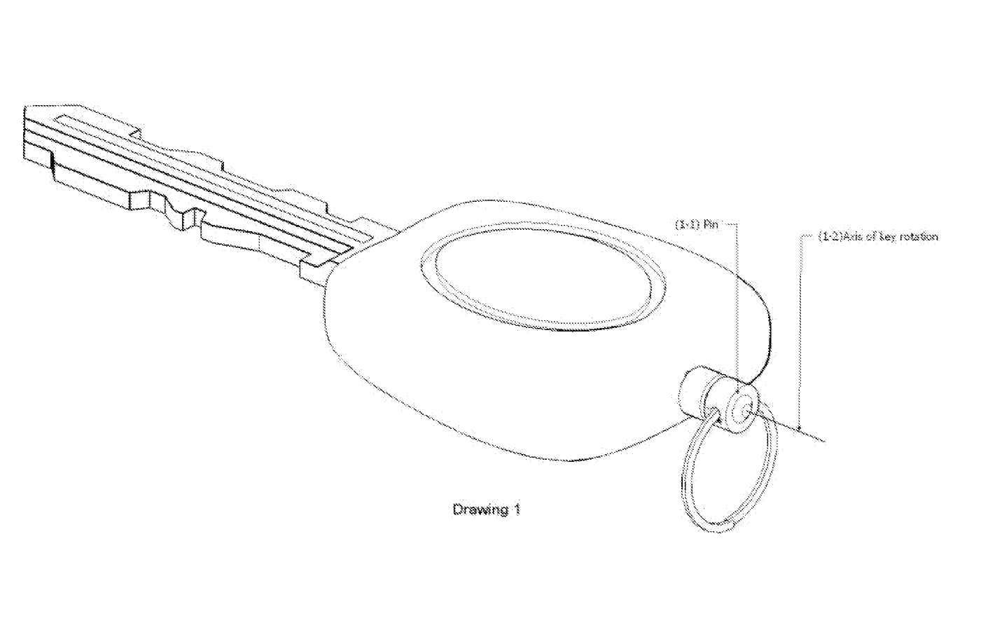

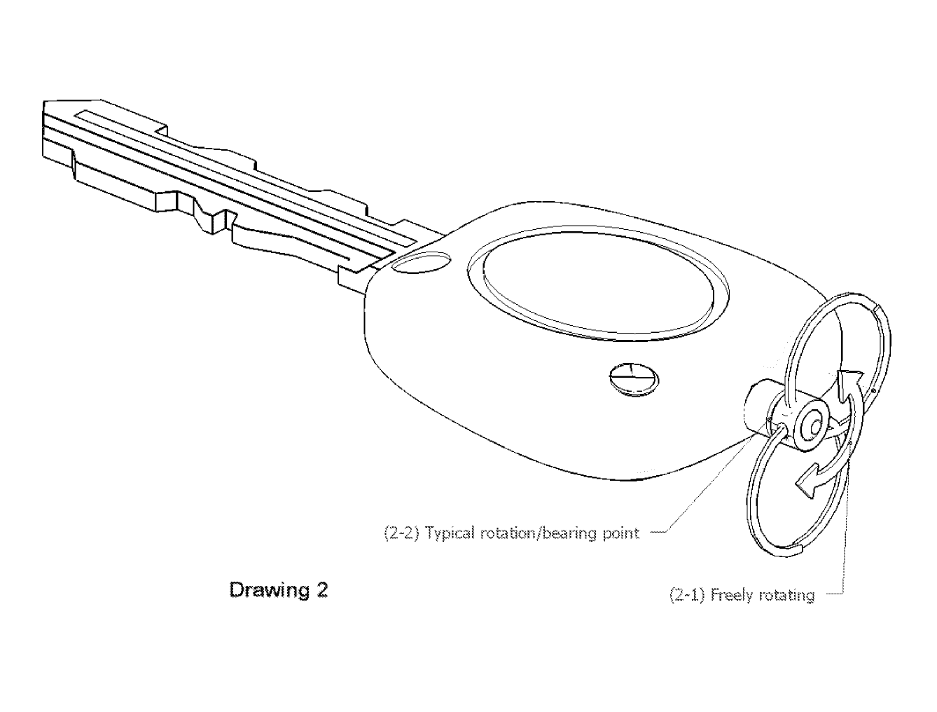

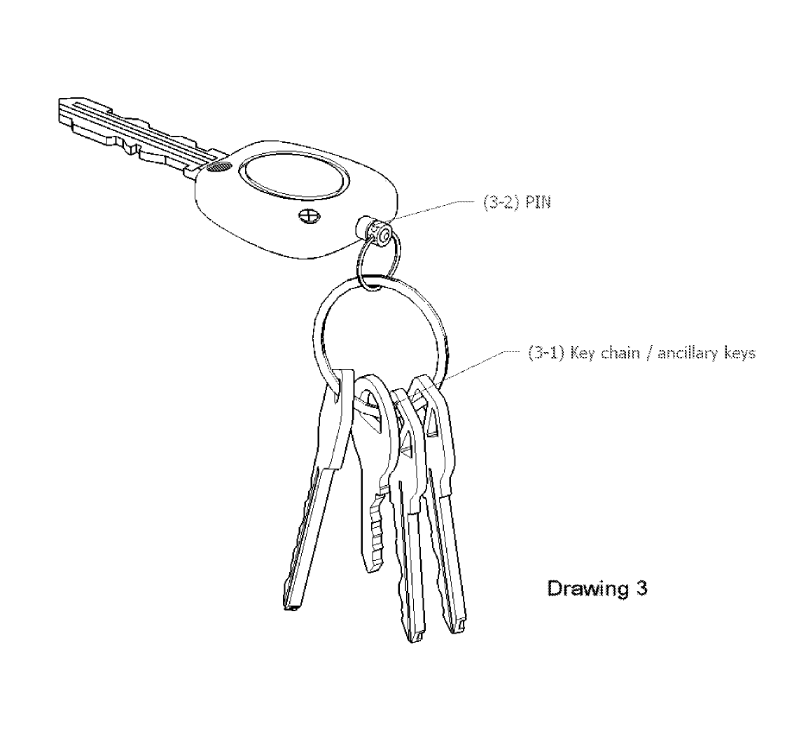

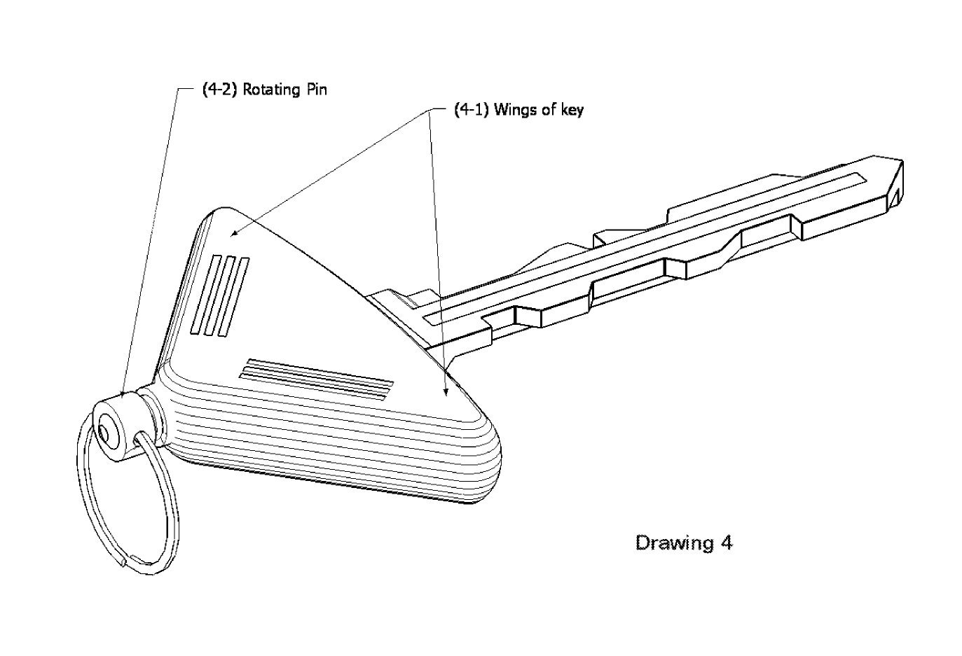

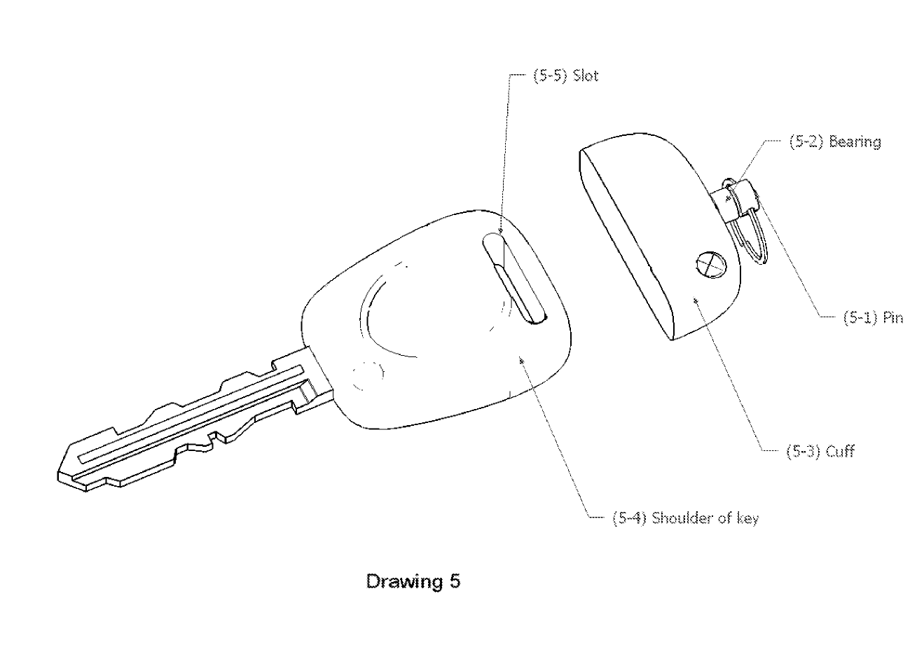

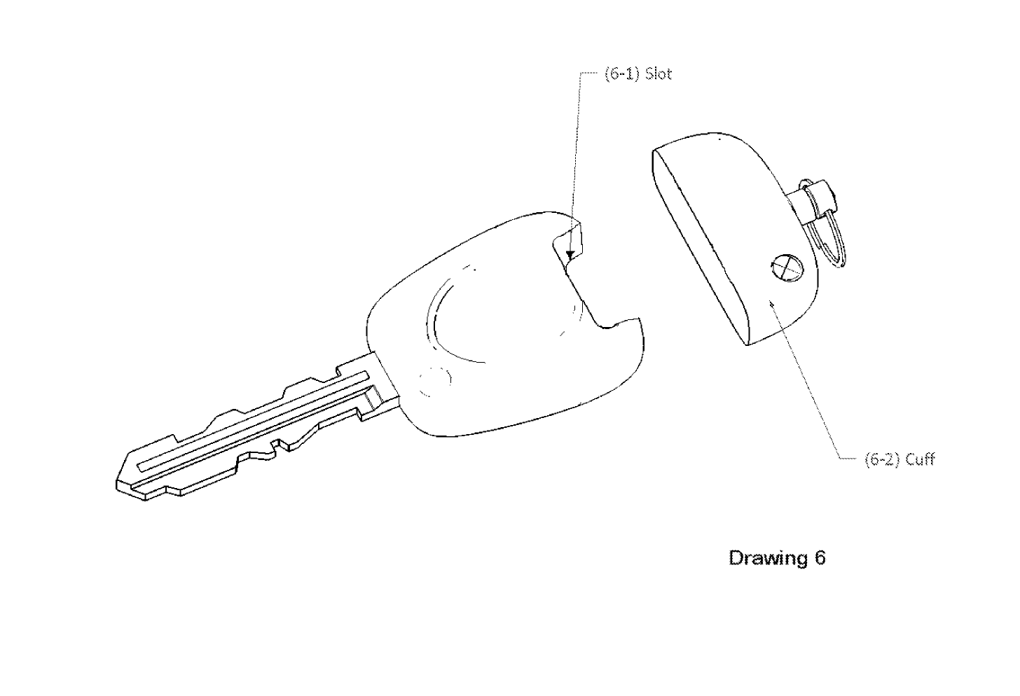

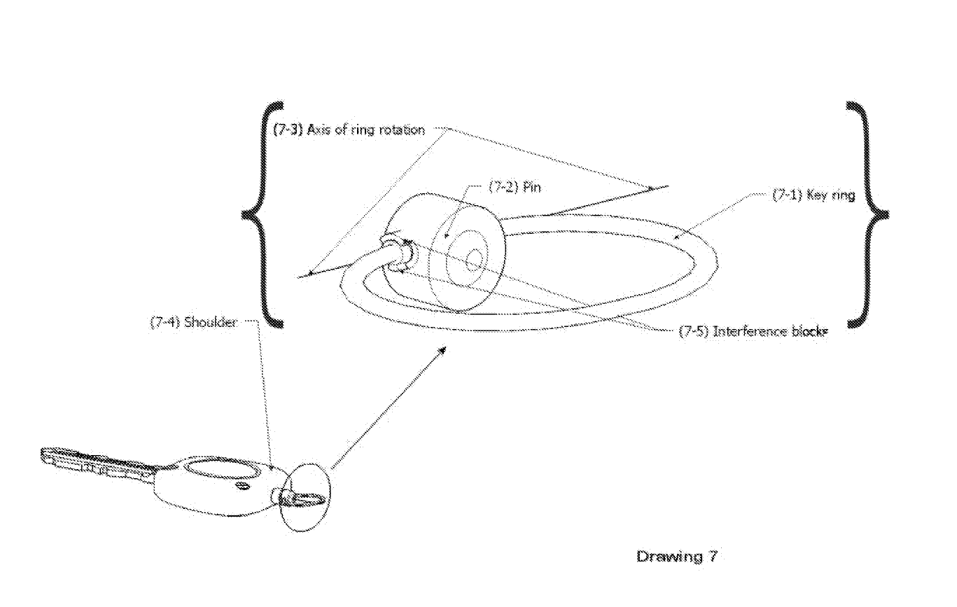

### CROSS-REFERENCE TO RELATED APPLICATIONS

Provisional application No. 62/044,484 covering this invention was applied for on Sep. 2, 2014 and was later unintentionally allowed to be declared abandoned on May 18, 2015. It was petitioned to be removed from abandonment on May 26, 2015, that petition has not yet been acted on.

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

In the first half of 2014 General Motors recalled as many vehicles as they had produced in the preceding 5 years, over 25 million vehicles in total. At the heart of these recalls was a faulty ignition switch that resulted in the cars being accidentally turned off. Tragically, this frequently occurred while the car was in motion and in some cases resulted in collisions and fatalities resulting in 65 wrongful death suits being filed as of August 2014. GM has been aggressive in attempting to fix this issue since the recalls were issued, but manufacturing capacity of the redesigned ignition switch, the complexity of the recall labor and the mere magnitude of the cars that need to be modified has made this a slow process. According to GM's website, GMauthority.com, as of Aug. 20, 2014, 6 months after the original recall, only 800,000 of the 2.59 million cars recalled, less than ⅓, had been fixed.

The problem exists because the torque necessary to move the ignition switch out of the running detent was inadequate. This condition allows the weight of the keys on a key chain during vehicle movement or an inadvertent bump of the keys or key chains to turn off the ignition. While a redesigned ignition switch, one requiring a higher torque to escape the run position detent, may alleviate this problem, a more simplistic solution is described herein to address the issue in total or to at least dramatically reduce the likelihood of further injuries until a redesigned ignition switch can be installed. GM has communicated to affected owners that if they remove all items from the key ring, leaving only the vehicle key, the vehicle is safe to drive. By doing this, the possibility of an unintended torque on the key which is adequate to turn the ignition off is essentially avoided. As was documented on FOX News many individuals are not heeding this warning whether due to inconvenience, lack of awareness or forgetfulness. Regardless of cause, these individuals remain at risk while GM continues to work through their recall backlog. If a key could be developed as taught herein to avoid this risk or at least substantially reduce it, GM could replace each key a car owner has for affected vehicles in a much abbreviated time frame potentially avoiding additional injuries and fatalities. Even if the more untimely and costly replacement of the ignition switch is still felt to be necessary, the modified key will provide relief from injury and liability in the interim and will provide an additional level of protection when the new ignition switches are installed.

### BRIEF SUMMARY OF THE INVENTION

The object of this invention is to avoid any undesirable torque from being transmitted to the ignition from the key. By a redesign of the key itself in the area of connection to a key chain or other keys this torque can be eliminated. The device described herein results in a connection to ancillary key chains or keys via a freely rotating pivot aligned along the axis of the key rotation. Torque generation requires a force at a lever arm around the axis of rotation. By eliminating the lever arm previously generated by a slot in the key or by binding of a key ring or chain on the key, the torque is also eliminated. The force generated by the weight, mass acceleration, or external “bumping” of the ancillary key chains or keys will be transmitted by a bending moment perpendicular to the axial rotation of the key or in a linear force along the axis of the key but none will be converted to torque that could accidentally turn off the ignition.

### BRIEF DESCRIPTION PRIMARY DRAWING

Drawing 1 shows a key designed in such a way that ancillary key chains or keys will be attached to a pin at the back of the key which freely rotates or pivots relative to the key on the same axial line as the key in the ignition rotates. As a result the key cannot translate a torque from the ancillary key chains or keys to the ignition switch that may accidentally change the state of the ignition.

### Drawings

Drawing 1 shows the fundamental design of the envisioned device whereby the pin (1-1) freely rotates along the axis of the key rotation (1-2).

Drawing 2 shows a typical embodiment of providing free rotation of the pin relative to the remainder of the key.

Drawing 3 shows ancillary key chains or keys attached to this pin demonstrating all stress placed on the key is transmitted through the pin and thereby unable to create a torque around the axis of the ignition.

Drawing 4 shows a typical embodiment of the design of “wings” on the key modified to decrease the exposed surfaces that can provide a moment of torque in the ignition should any force be inadvertently applied.

Drawing 5 shows the same functionality of the key previously described obtained by a cuff (5-3) which attaches to existing keys.

Drawing 6 shows a cut out a portion of the “slot” (6-1) that ensures it cannot be subsequently reused.

Drawing 7 shows a method of further assurance that the ancillary key rings or keys cannot hang on the wings of the key by limiting the degree to which an integrated ring can fold back toward the shoulder of the key.

### DETAILED DESCRIPTION OF THE INVENTION

Definitions used:

Ancillary key rings or keys—refers to any combination of key chains, key rings, keys, key fobs or other items carried on a key ring or chain including but not limited to lights, nail clippers, bottle openers etc. which may be attached to the vehicle key but are not used in the ignition.

Pin—the mechanism positioned at the back of the key directly opposite the tip of the key that enters the ignition lock. This may take the form of a round pin or small axle, but may also be of any shape capable of attaching to an ancillary key rings or keys and providing free rotation between the key and ancillary key rings or keys along the axis of the ignition switch rotation.

Bearing—a device that minimizes rotational friction; this may be a ball bearing or roller bearing device or low static and dynamic frictional surfaces. For the purposes of the specification, the bearing shall provide for low resistance to rotation between the pin and the ignition key along the axis of the ignition switch rotation.

Ignition Switch—used throughout the specification to focus on the specific problem with faulty ignition switches in vehicles, specifically those involved in the 2014 GM recalls. However, for the purpose of scope of devices covered by the patent, this should be defined as expanded to any keyed lock that is activated and deactivated by rotation. For example the lock on a freezer door would also be well advised to take advantage of the device described within and is intended to be included in the scope of the specification

Key—where shown in bold in this specification unless otherwise declared, refers to the key that is inserted into the switch being protected as distinguished from others “key(s)” that may be attached to the key or an ancillary key ring, chain or otherwise.

### Description:

See Drawing 1. The redesigned key envisioned would have a small connection typically an axle or pin (1-1) projecting from the rear of the key away from the tip which inserts into the ignition. The pin's axis of rotation will be the same as the axis of rotation of the key (1-2) when engaging the ignition switch. See Drawing 2. This pin will be freely rotating (2-1) as enabled by a bearing internal to the key or along the pin (2-2).

See Drawing 3. Ancillary key rings or keys (3-1) would be attached to this pin (3-2) resulting in all stress placed on the key being transmitted through the pin and thereby would not create a torque on the key around the axis of the ignition.

See Drawing 4. Optionally the general design of the “wings” (4-1) on the key may be modified to decrease the exposed surfaces that can provide a moment of torque in the ignition should any force be inadvertently applied directly to the key. This concept can be implemented both with or without the rotating pin (4-2) as previously described.

Optionally the functionality of the redesigned key described above can be obtained through a retrofit for existing keys. This may be desirable to minimize the cost of having new keys cut to match the existing ignition locks and the additional costs of RFID or other security enabled keys. See Drawing 5. This would be accomplished by embedding the pin (5-1) and bearing (5-2) into a cuff (5-3) that would be attached over the shoulder (5-4) of the existing key. The cuff would cover and render unusable the existing connection slot (5-5) for ancillary key rings or keys.

See Drawing 6. In the case of retrofitting a key as described above it may be prudent or advantageous to cut out a portion of the “slot” (6-1) when the cuff (6-2) is installed to insure it cannot be subsequently reused. This may concurrently provide the advantage of additional room for the bearing mechanism within the cuff minimizing its overall bulk.

Further assurance that the ancillary key rings or keys cannot “hang up” on the wings of the key is taught in the patent and depicted in Drawing 7. In this enhancement to the device, a key ring (7-1) is designed and attached to the pin (7-2) of the key is such a manner that the rotation of the ring on an axis (7-3) perpendicular to the axis of the key is limited such that it cannot fold back onto the shoulder (7-4) of the key. One embodiment of this limitation can be accomplished by the interference blocks (7-5) shown in the enlarged area of the drawing. This further isolates the ancillary key rings or keys from any interaction with the key other than through the pin which avoids producing torque in the ignition switch.

I claim:

1. A modification to a typical key whereby a pin is designed into the rear of the key such that it rotates freely along the axis of the key rotation when engaging a lock, said pin shall enable the attachment of ancillary key rings or keys.

2. The device in claim 1 whereby a ring is attached to the pin in such a manner that its rotation on an axis perpendicular to the axis of the key is limited to 240 degrees or less in order to prevent potential interference with the shoulder of the key.

3. The device in claim 1 whereby the wings of the key are modified to reduce areas where a tangential force can be inadvertently applied or where ancillary key rings or keys could hang if bounced or otherwise made to come in contact with the key wings.

4. The device in claim 3 whereby a ring is attached to the pin in such a manner that its rotation on an axis perpendicular to the axis of the key is limited to 240 degrees or less in order to prevent potential interference with the shoulder of the key.

5. A cuff designed to be attached to the back of an existing key rendering the existing connection slot or hole inaccessible and containing a pin designed into the rear of the cuff such that it rotates freely along the axis of the key rotation when engaging a lock, said pin shall enable the attachment of ancillary key rings or keys.

6. The device in claim 5 whereby the slot in the existing key is cut out of the back of the key rendering the slot unusable.

7. The device in claim 5 whereby a ring is attached to the pin in such a manner that its rotation on an axis perpendicular to the axis of the key is limited to 240 degrees or less in order to prevent potential interference with the shoulder of the key.

8. The device in claim 7 whereby the slot in the existing key is cut out of the back of the key rendering the slot unusable.

9. A modification to a typical key whereby the wings of the key are modified to reduce areas where a tangential force can be inadvertently applied or where ancillary key chains or keys could hang if bounced or otherwise made to come in contact with the key wings.
